(19) United States
(12) Patent Application Publication
(10) Pub. No.: US 2010/0322770 A1
(43) Pub. Date: Dec. 23, 2010

(54) TURBINE BLADE CONSTRUCTIONS PARTICULAR USEFUL IN VERTICAL-AXIS WIND TURBINES

(75) Inventor: Yehoshua Sheinman, RaAnana (IL)

Correspondence Address: MARTIN D. MOYNIHAN d/b/a PRTSI, INC., P.O. BOX 16446, ARLINGTON, VA, 22215, US

(73) Assignee: CORIOLIS-WIND INC., WILMINGTON, DE (US)

(21) Appl. No.: 12/744,971

(22) PCT Filed: Dec. 2, 2008
(86) PCT No.: PCT/IL08/01567

§ 371 Date: May 27, 2010

Related U.S. Application Data
(60) Provisional application No. 60/996,755, filed on Dec. 4, 2007.

(51) Int. Cl. F03D 3/00; F03D 11/00

(52) U.S. Cl. 416/176; 416/242

(57) ABSTRACT

A turbine blade particularly useful in a vertical-axis wind turbine, characterized in that the blade includes a central region of a symmetrical airfoil configuration, and opposite end regions of a non-symmetrical airfoil configuration effective to increase the drag forces produced by the wind at the end regions when the turbine blade is used in a vertical-axis wind turbine provide a self-starting capability, and a speed-limiting capability, to the wind turbine. In one described embodiment, the non-symmetry in the sharp trailing edge of the blade is produced by a deep recess extending inwardly past the chord line of the blade to enhance the self-starting and speed-limiting capabilities; whereas in another described embodiment, the non-symmetry is produced by a shallow recess and outwardly-flared ends enhancing the efficiency of the wind turbine during normal wind conditions.

### FIELD AND BACKGROUND OF THE INVENTION

The present invention relates to turbine blade constructions particularly useful in vertical-axis wind turbines, and also to wind turbines including such turbine blades. The invention is particularly useful with respect to vertical-axis wind turbines of relatively small diameter for converting wind energy into electrical energy in order to reduce the dependency on fossil fuels for this purpose, and the undesirable effects to the atmosphere in burning fossil fuels.

For the foregoing reasons, there is an increasing global trend to generate renewable energy to replace fossil fuels in various applications requiring large consumptions of energy. One of the attractive areas is in the installation of renewable energy devices particularly in urban environments. The connection of installations of such renewable energy sources to the electrical grid can be facilitated by: private ownership of the property and of the generating device, the use of existing electrical infrastructure, the lack of governmental involvement, lack of a need for transmission/the low transportation cost, etc. In many locations the authorities are encouraging such installations by granting subsidies for purchasing renewable energy devices or by allowing the device owners to sell the produced electricity at higher tariffs.

Photovoltaic panels, installed on the roofs of residential or commercial building have proliferated in the last few years. In certain geographical areas, however, the density of the wind energy is higher than that of solar energy, and therefore such areas may be better used for small wind turbine installations.

Several attempts have been made to examine the feasibility of wind turbine installations on roofs. Most of the tested devices were horizontal axis turbines (propeller type) where the turbines were mounted on masts elevated from the roof surface. Since wind flow along lines close to the roof are highly turbulent (having strong dynamics in all three dimensions), the propeller type turbines often failed to accomplish the task. The failure was generally attributed to the high vibrations and mechanical stresses induced by the three-dimensional flow. In order to minimize this effect, rotors need to be located at more stable wind flow regimes, which can be achieved by using higher masts. Moreover, this leads to construction problems (i.e. larger movements on the roof structure), and to aesthetic problems, and as a result consumers usually reject this approach.

Additional efforts were made to adopt lift based vertical-axis wind turbine designs for roof mounting. These solutions are less sensitive to turbulence, especially to the vertical component of the wind flow (the shear component). Unfortunately, these designs require a mast in order to maintain high conversion efficiency by installing the turbines in more uniform wind flow stream lines. As in the horizontal-axis turbine case, this additional mast introduces vibrations, instability, noise, foundation construction, and aesthetical problems.

Vertical-axis wind turbines (VAWT) have been described in numerous US and foreign patents. Many attempts were presented to increase the dimensions and capacity of these turbines and to obtain better cost-effective characteristics as compared to the horizontal axis (propeller type) wind turbines—HAWT). On the other hand, less effort has been invested on small size vertical-axis wind turbines.

The small size (rated in the range of up to tens kilowatts) vertical-axis wind turbines (VAWT) are generally divided into two categories:

1. drag based machines in which the wind energy is converted to rotational energy using the drag forces applied by the wind across the turbine's rotor; and

2. lift based machines in which the wind energy is converted to rotational energy using lift forces resulting from airflow over the turbine's blades.

Drag machines are characterized by a relatively low rotational speed compared with lift machines. As the canoe will never ride faster than its paddle, the drag machine's rotor will never ride faster than the wind. This characteristic is expressed mathematically by the Tip Speed Ratio (TSR or λ).

λ=ωr/V, where:

ω—is the rotor angular speed,

r—is the blade radius, and

V is the horizontal component of the blowing wind

The value of λ for drag machines is lower than “1”.

For electricity generation applications, where the main requirement is to convert the wind energy to rotational energy as efficiently as possible, drag machines are not as efficient as horizontal-axis propeller type wind turbines. Therefore, although they are simpler and less expensive to build, and do not require re-orientation with the changes in wind direction, drag machines are presently not popular for electricity generation.

The principles of operation of a conventional lift-based vertical-axis wind turbine are depicted in FIG. 1, illustrating various blade positions and their associated resulting aerodynamic forces.

The conversion efficiency of lift based machines is usually superior to that of drag machines, due to the range of 1:10 to 1:100 between the drag and lift coefficients of a typical blade. As shown in FIG. 1, the torque generated by the blade (via the generated force in the rotation direction) is limited to two sectors (namely sectors AOB and COD) along the entire rotational circumference. The lift force is dependent on the incident angle. The useful incident angle range within the sectors (of a specific blade) is related to (i) the instantaneous angular position, (ii) the horizontal component of the wind, and (iii) the angular speed of the blade, i.e., ω.r.

In order to enlarge the useful incident angle range within the sectors (the basic requirement being: ωr>>V, or λ>>1), the blade speed needs to be larger than the wind speed. Various types of blade-pitch mechanisms (hydraulic, by cams, etc.) have been proposed to increase the useful incident angle range, but these usually involved unduly complicated mechanisms.

One of the possibilities to reduce the VAWT cost is to avoid the use of a gearbox between the rotor and the generator. This gearbox is used to increase the speed of the rotor shaft to a speed suitable for commercial generators (˜1000 RPM). Several attempts were made to introduce permanent magnet (PM) generators, having a plural number of poles, thus producing very low rotation speed. The results indicated that as the rotational speed was reduced, the cost of the generator was increased and its efficiency of energy conversion was reduced.

One of the main requirements for a small VAWT is to be able to work efficiently at low TSR (λ) values. This range can ensure less noisy rotation, and less stresses and fatigue forces on the blades. The range of low TSR values for efficient lift based VAWT is: 2<λ<3.

Another reason to adopt low TSR values for a lift based VAWT is the structure of the streamlines passing the turbine. FIG. 2 illustrates the cyclic-average mean streamlines passing a VAWT operating at a tip speed ratio of 4.5 with a counter-clockwise rotation. The streamlines are skewed with a counter-clockwise rotation at the downwind side of the turbine. This skew can be a disadvantage in cases where several VAWT are located in-line, and close to each other. As the flow is low subsonic, the skewed streamlines of one turbine can collide with the streamlines of the adjacent turbine. This phenomenon can cause reduction in the efficiency of both turbines. However, as the distance between the turbines is increased, the density of turbines per area unit is decreased.

On the other hand, coupling the low TSR requirement (a moderate TSR value can be λ=2.5), with direct-coupled low-speed PM generator having a moderate rated speed (−250 RPM), restricts the size of the rotor's radius. In such a case, the radius size would be 1≦r≦1.5 m. This limits the size of the VAWT to “small”.

An optional way to increase the surface area of the turbine, in order to increase its capacity although its radius size is limited, is to increase its height H. A turbine having H/2r ratio>>1 is generally called a “high aspect ratio” (HAR) turbine.

Although turbines having dimensions of H/2r<3 are available, turbines having larger ratios are not common. The reason is related to the major disadvantage of the HAR turbine, which is the blade-capacity ratio, or the ratio between the length of the blades and the turbine capacity. In HAR turbines case, this ratio is high, versus regular VAWT and very high versus HAWT. As blades are expensive, if each blade is produced as an integral unit, it might turn the HAR turbine to be uncompetitive to the VAWT.

Another disadvantage of VAWT's rotor having straight blades is the fluctuating torque produce by the blade surfaces while they are crossing and coasting the wind direction. Goldberg U.S. Pat. No. 5,405,246, describes a HAR VAWT which includes two or more elongated blades connected to a rotor tower. Each blade is “twisted” so that its lower attachment point is displaced angularly relative to its upper attachment point. The orientation of each blade is tangential to the local radius. The blade section length of each blade is disclosed as being shorter near the midpoint of each blade and longer near the ends of each blade. The ratio between the blade section length and the blade thickness is disclosed as being constant over the length of each blade. The twisting of the blades helps somewhat to even out the torque produced by the turbine during its revolution since a portion of at least one blade is crossing the wind direction at all times and thus the overall turbine is never completely in a coasting state.

A further well-known disadvantage of the vertical-axis lift machine is its tendency to accelerate at high-speed winds, which can result in a destructive rotational speed. The common prior art solutions to overcome this challenge include electrical loading via the generator, braking disks or drums, or pitching the blades to reduce the lift forces. Each of these solutions, however, increases the system's complexity and therefore its price as well as its maintenance requirements.

Another drawback of lift machines is their inability to “self start”. Present solutions to this limitation using helical blades, or three (and more) blades in a rotor, or both, to overcome this problem are not entirely satisfactory; moreover the wind speed needed to start the rotor (“cut in” speed) in such solutions is relatively high.

### OBJECTS AND BRIEF SUMMARY OF THE PRESENT INVENTION

An object of the present invention is to provide a novel turbine blade structure having advantages in one or more of the above respects making it particularly useful for vertical-axis wind turbines. Another object of the invention is to provide a vertical-axis wind turbine constructed with such turbine blades.

According to one aspect of the present invention, there is provided a turbine blade particularly useful in a vertical-axis wind turbine, characterized in that the blade includes a central region of a symmetrical airfoil configuration, and opposite end regions of a non-symmetrical airfoil configuration effective to increase the drag forces produced by the wind at the end regions when the turbine blade is used in a vertical-axis wind turbine, sufficient to provide a self-starting capability, and a speed-limiting capability, to the wind turbine.

According to further features in the described preferred embodiments of the invention, the blade is constructed of a plurality of segments joined to each other end-to-end, with each of the segments including the central region of symmetrical airfoil configuration, and the end regions of non-symmetrical airfoil configuration. The symmetrical airfoil configuration of the central region is of a tear-drop configuration, including a rounded leading edge, a sharp trailing edge, and a chord line extending from the rounded leading edge to the sharp trading edge midway between the outer surfaces of the turbine blade; and the non-symmetrical airfoil configuration of the end regions includes an inwardly-extending recess at the sharp trailing edge of each end region.

In some described preferred embodiments, the inwardly-extending recess is a deep recess extending inwardly past the chord line at the sharp trailing edge of the blade to thereby increase the drag forces and thereby enhance the self-starting and speed-limiting capabilities. In these embodiments, the central region and the end regions have chord lines of equal lengths.

In other described preferred embodiments, the inwardly-extending recess is a shallow recess and terminates short of the chord line at the sharp trailing edge to thereby enhance the efficiency of the wind turbine at normal wind speeds. In these described embodiments, the chord lines are of the same length in the central region, and of increasing length from the central region to the outer ends of the end regions, to define an outwardly-tapered or flared end region at each of the opposite ends of the central region.

As will be described more particularly below, the first described embodiments including deep recesses are particularly useful to enhance the self-starting and speed-limiting properties of the wind turbine, whereas the second described embodiment including the shallow recesses and outwardly-tapered or flared end sections are particularly useful to increase the operating efficiency of the wind turbine.

According to yet another aspect of the invention, there is provided a turbine blade particularly useful in a vertical-axis wind turbine, the blade including a rounded leading edge and a sharp trailing edge; characterized in that the blade includes a central region having chords of equal length, and end regions on the opposite ends of the central region having chords of increasing length towards the outer tip of each end region.

According to another aspect of the invention, there is provided a vertical-axis wind turbine, comprising: a plurality of blades mounted to a vertical rotary shaft by coupling arms at the opposite ends of each blade to define a rotary blade assembly in which the blades are circumferentially spaced from each other and their ends are radially spaced from the vertical rotary shaft; characterized in that the plurality of blades have a helical configuration in which the helical direction of each blade is opposite to the direction of rotation of the rotor assembly, such that the bottom parts of the helical blades lead the top parts of the helical blades during the rotation of the rotary blade assembly. This feature produces a more uniform torque output.

Further features and advantages of the invention will be apparent from the description below.

### BRIEF DESCRIPTION OF THE DRAWINGS

The invention is herein described, by way of example only, with reference to the accompanying drawings, wherein:

FIG. 1 diagrammatically illustrates the operation of a conventional lift-based vertical-axis wind turbine as briefly discussed above;

FIG. 2 diagrammatically illustrates the air flow with respect to relatively thin turbine blades;

FIG. 3 diagrammatically illustrates the air flow with respect to relatively thick turbine blades;

FIG. 4 diagrammatically illustrates one embodiment of the present invention wherein a non-symmetry at the sharp trailing edge of each turbine is produced by a deep recess in order to increase the drag and thereby to enhance the self-starting and speed-limiting capabilities of the wind turbine;

FIG. 5 diagrammatically illustrates the air flow with respect to the non-symmetrical configuration of FIG. 4;

FIGS. 6A and 6B diagrammatically illustrate the operation of a vertical-axis wind turbine constructed with the deep recess in the trailing edge facing inwardly (FIG. 6A) or facing outwardly (FIG. 6B) with respect to the vertical rotary axis;

FIG. 7 diagrammatically illustrates a rotor blade assembly constructed with turbine blades according to the structure of FIG. 4, with only one segment of one turbine blade being illustrated for purposes of simplicity;

FIG. 8 illustrates a rotary blade assembly similar to that of FIG. 7 but utilizing a turbine blade constructed in accordance with a second embodiment of the invention;

FIG. 9A diagrammatically illustrates various parameters, and the path of movement, of the turbine blade constructed according to FIG. 8;

FIGS. 9B and 9C illustrate the turbine blade of FIG. 9A in two positions to better show the construction of the turbine blade;

FIGS. 10 and 11 illustrate various sections in the structure of the turbine blade of FIG. 7; and

FIG. 12 is a view similar to that of FIG. 11 but illustrating a turbine blade as having a negative camber, rather than a positive camber as in FIG. 11.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### A PRIOR ART CONSTRUCTION

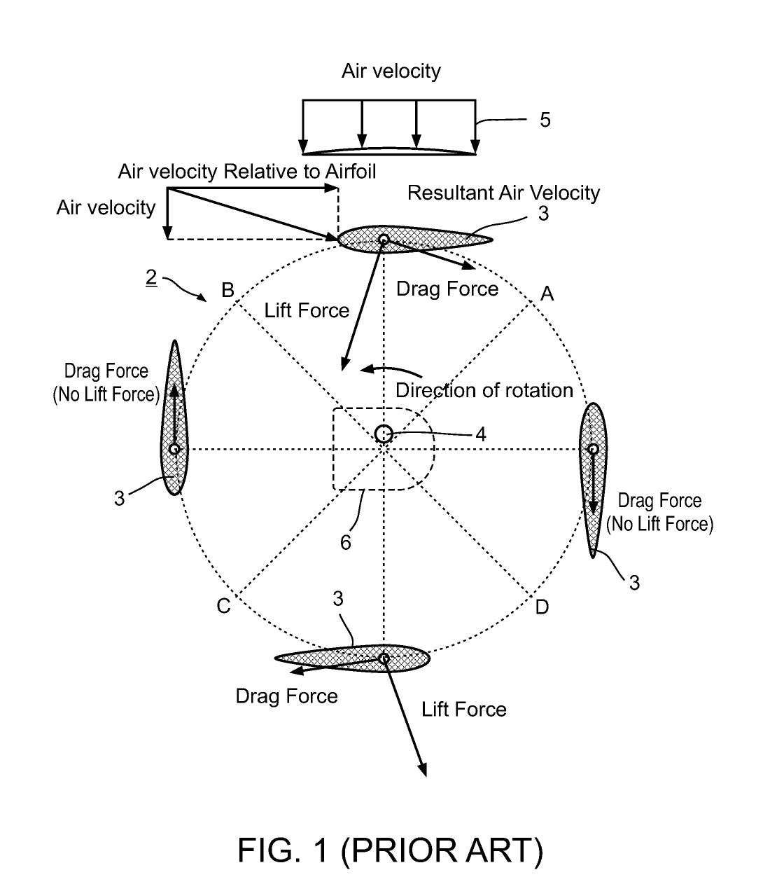

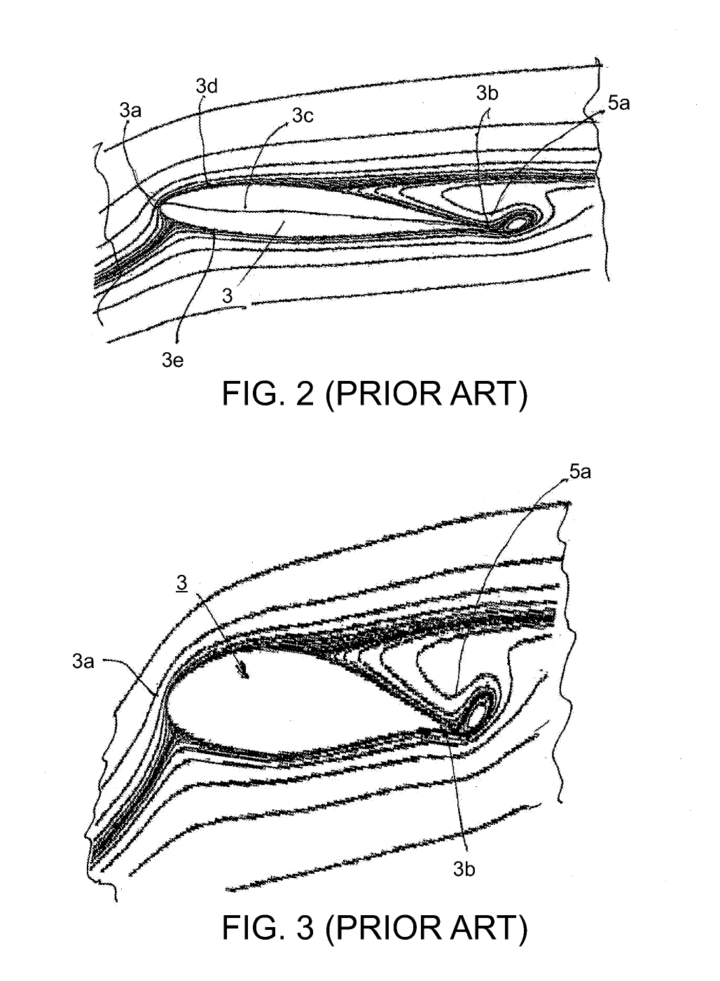

As indicated earlier, FIG. 1 diagrammatically illustrates the operation of a prior art lift-type vertical-axis wind turbine, whereas FIGS. 2 and 3 illustrate the air flow patterns with respect to a thin turbine blade (FIG. 2) and a thick turbine blade (FIG. 3), both of a symmetrical, tear-drop, airfoil configuration.

The vertical-axis wind turbine diagrammatically illustrated in FIG. 1, includes a rotary assembly, generally designated 2, of a plurality of turbine blades, one of which is shown at 3, coupled to a vertical rotary shaft 4 so as to rotate the shaft 4 when driven by the wind, schematically shown at 5. Vertical rotary shaft 4 is coupled at its lower end, usually via a gear transmission mechanism, to a generator schematically shown by broken lines 6 in FIG. 1, to convert the rotational energy generated by the rotation of the turbine blades 3, to electrical energy. As indicated earlier, the torque generated by the turbine blades is substantially limited to two sectors, sector AOB and sector COD in FIG. 1.

The symmetrical airfoil configuration of each turbine blade 3 is more particularly illustrated in FIG. 2. Thus, the blade is of a tear-drop configuration, including a rounded leading edge 3a, a sharp trailing edge 3b, and a chord line 3c extending between the two edges midway between the outer surfaces 3d and 3e of the blade. Chord line 3c also serves as the mean camber line, defining an upper camber between it and outer surface 3d, and a lower camber between it and the lower surface 3e.

FIG. 2 also illustrates the air flow produced around the symmetrical air foil configuration illustrated therein, wherein it will be seen that the lift forces are generated primarily at the rounded leading edge 3a, depending on the angle of attack, whereas the drag forces are generated primarily at the sharp trailing edge 3b where a notch 5a of turbulence is produced. As shown in FIG. 3, the drag forces are increased by increasing the thickness of the turbine blade which thereby increases the notch 5 of turbulence.

As indicated earlier, drawbacks in turbine blades of a symmetrical configuration, as illustrated in FIGS. 2 and 3, are their inability to self-start, their tendency to accelerate at high-speed winds resulting in destructive rotational speeds. Another tendency is to produce a fluctuating torque while the blade surfaces are crossing and coasting the wind direction.

### THE PRESENT INVENTION

The present invention provides a turbine blade structure, and also a vertical-axis wind turbine using such blades, having advantages in one or more of the above respects, thereby making such blades particularly useful for vertical-axis wind turbines (VAWT).

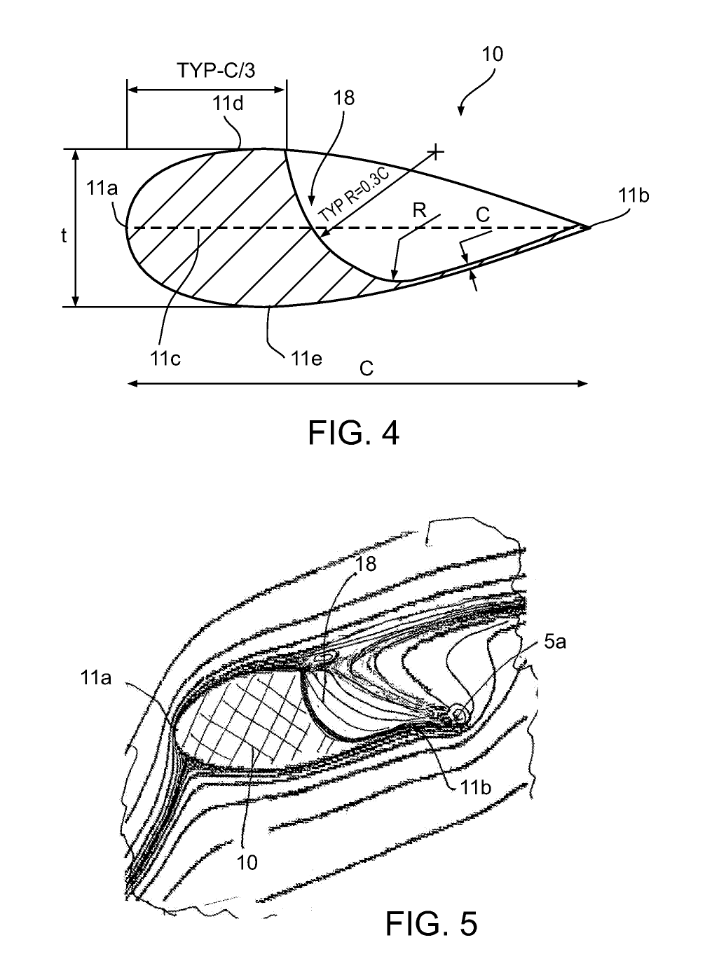

The invention is described below, for purposes of example only, with respect to several embodiments described below in FIGS. 4-7 and 8-12, respectively. In all the described embodiments, the blade, preferably each segment of the blade, includes a central region of the symmetrical tear-drop airfoil configuration as described above with respect to FIG. 2, and opposite end regions of a non-symmetrical configuration effective to increase the drag forces produced by the wind at the end regions. Accordingly, when the turbine blade is used in a vertical-axis wind turbine, the non-symmetrical end regions enhance the self-starting capability, and the speed-limiting capability, of the wind turbine.

Preferably, each blade is constructed of a plurality of segments joined to each other in end-to-end relationship, and is formed in a helical configuration with the helix extending in a direction opposite to that of the direction of rotation of the blade. Such features not only increase the operating efficiency of the blade during normal wind conditions, but also reduce the torque fluctuations referred to above in the conventional vertical-axis wind turbine.

### The Embodiments of FIGS. 4-7

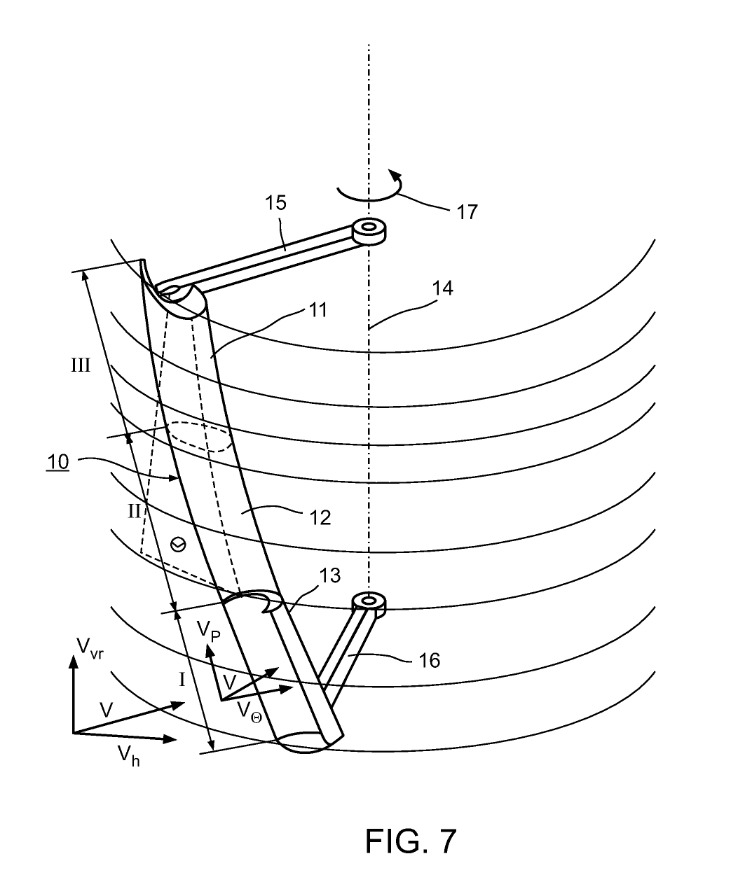

FIG. 7 illustrates one blade, generally designated 10, of a rotor blade assembly, constructed in accordance with the present invention. It will be appreciated that the illustrated turbine blade 10 may constitute a complete turbine blade, but preferably it constitutes but one segment of a complete turbine blade, having a plurality of such segments built up in an end-to-end relationship to form one of the complete turbine blades of the rotary blade assembly.

Turbine blade 10 includes three regions: an outer region 11 at one end, a central region 12, and another outer region 13 at the opposite end. The turbine blade is mounted in a twisted or helical configuration to a rotary shaft 14, by a pair of arms 15, 16 at the opposite ends of the turbine blade, such that the turbine blade rotates in the counter-clockwise direction, as indicated by arrow 17, to thereby rotate the central shaft 14 and to generate electricity by a generator coupled to that shaft as described above with respect to FIG. 1. As shown in FIG. 7, the blade is twisted to a helical configuration with the direction of the helix opposite to the direction of rotation indicated by arrow 17, such that the lower end of the blade leads the upper end during the rotation of the blade. This configuration uses the vertical components of the wind for torque generation, while the trailing edge is used as a drag mechanism.

The central region 12 of blade 10 or the segment therefore, as illustrated in FIG. 7, is of a symmetrical airfoil configuration, as described above with respect to FIG. 2, for example. However, its end regions 11 and 13 are of a non-symmetrical configuration in which the sharp trailing edges are “sliced”, or formed with inwardly-extending recesses, as illustrated in FIG. 4 with respect to outer region 11.

Thus, as shown in FIG. 4, the outer region 11 of turbine blade 10 is of a non-symmetrical airfoil configuration, including a rounded leading edge 11a, a sharp trailing edge 11b, and a chord line 11c extending between the leading and trailing edges. As indicated above, in a symmetrical airfoil configuration, the chord line 11c extends midway between the upper surface 11d and lower surface 11e of the turbine blade. However, in the non-symmetrical structure illustrated in FIG. 4, the trailing edge 11b of the blade is “sliced” or formed with a deep recess 18, which recess extends inwardly past the chord line 11c to define a thin shell “S” with surface 11c at the trailing edge.

As indicated earlier, the deep recess 18 in the trailing edge 11b of the two outer regions 11, 13 of blade 10 increases the drag forces produced during the rotation of the blade by the wind, as shown in FIG. 5. This increase in the drag force enhances the self-starting capability of the rotary assembly, and also enhances the speed-limiting capability during high wind conditions.

FIG. 4 illustrates an example of the preferred dimensions of outer region 11 of blade 10. Thus, the deep recess 18 is formed a distance from the rounded leading edge 11a which is less than one-half, preferably one-third, the length (C) of the chord line 11c, and has a radius of curvature equal to 0.3 C. The length of chord (C), and its thickness (t), may be the same as in a standard thick symmetrical airfoil (like the NACA0030 or NACA0040).

The secondary radius R* is determined mainly by production considerations. The thickness of the shell “S” formed in the uncut trailing edge is based on strength, blade stiffness and production considerations.

The flow lines around the sliced airfoil 10 are shown in FIG. 5. It is clear that the small vortex 5a at the sliced trailing edge, as well as a reduction in the airflow speed at the trailing edge, will contribute to a decrease in the lift (around 10-20% decrease) and to an increase in the drag (around 5%).

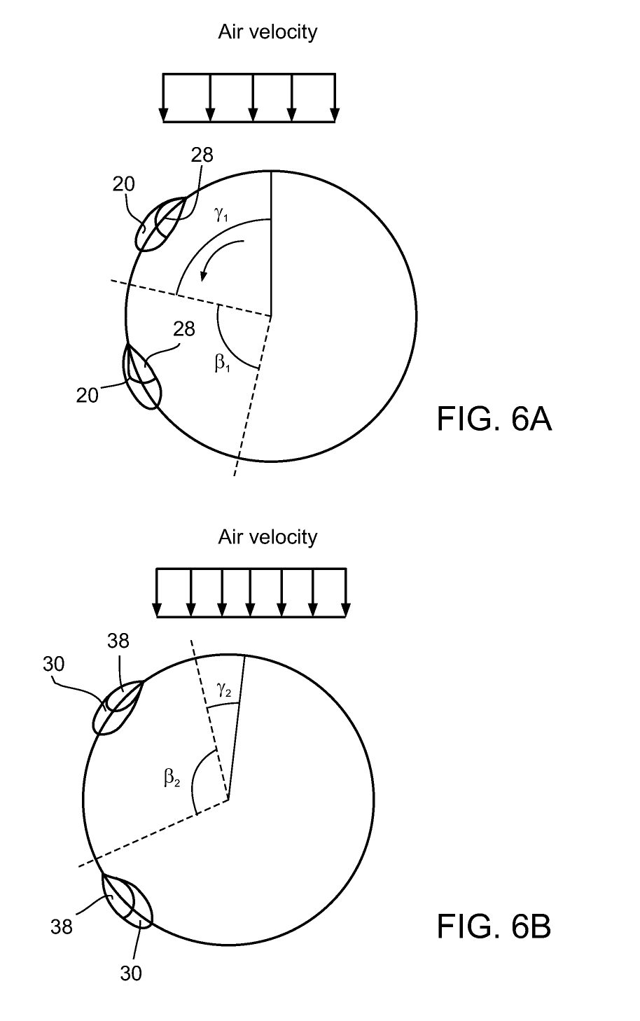

FIG. 6a illustrates an airfoil 20, which is “sliced” (i.e., formed with the inwardly-extending recess 18 at its trailing edge) to deflect the airflow into the rotor rotation circle, and FIG. 6b illustrates the airfoil formed with the same sliced profile but in the opposite surface to deflect the flow out of the rotation circle. FIG. 6a also illustrates the zone in which the airfoil functions as a drag device, with ‘into the rotor deflection’. For a specific air velocity vector, the angle of starting γ1 is measured from this vector direction. The operating zone itself can be defined by the angle β1. FIG. 6b illustrates the zone in which airfoil 30 functions as a drag device with ‘out of the rotor deflection’. The angle of starting γ2 is measured from this vector direction similar to the angle γ1. The operating zone itself can be defined by the angle β2.

If a single blade possesses, in different segments of the blade, both in and out deflection capabilities, the combined beneficial zone of the drag machine is quite wide. This combination is presented in FIG. 7 illustrating a single twisted blade, which is a part of a rotor. The blade has a helix angle θ, and is divided into 3 segments 11, 12, 13, as described above. The top segment is constructed from a “sliced” blade 10 having into the rotor deflection along a span III. The middle segment is constructed from a non-sliced (symmetrical) airfoil 12 along a span II; and the bottom segment is constructed from a sliced blade (13) having out of the rotor deflection, along the span I. While the lift part of the blade is generating torque from the horizontal component vh of the wind vector V (and the vertical component vv is parasitic), the drag part of the blade divides V into the components vθ and vp, and makes use of a significant part of vv.

The following general principles should be applied in optimizing the blade structure and the design in the above-described embodiments, as well as in the embodiments to be described below.

The standard lift machines are equipped with symmetrical airfoil in the range of NACA 0012-NACA 0018. These airfoils have a thickness to chord length ratio of 12% to 18%.

The novel blade described above uses an airfoil which preferably has a thickness to chord length ratio of 30%-40% resulting in lower lift, and higher drag. On the one hand, the lift vs. the incident angle slope is less steep, but on the other hand the stall in such a configuration occurs at higher angles. The thick airfoil therefore provides a larger working zone by permitting larger incidence angle values. The use of a thick airfoil increases the drag but reduces the overall generated torque. At unsteady wind flow conditions, and in silent environments (which are typical roof conditions), this reduced torque is less important than the possibility to gain a larger working zone.

The typical lift machine chord is calculated from the solidity definition of the rotor: σ=N*c/Dr, where N is the number of blades, c is the blade chord, and Dr is the diameter of the rotor. The new blade construction described above is adequate for σ=1. In this case the chord length c=Dr/N.

The trailing edge in the above-described blade is “sliced”. i.e., it is formed with an inwardly-extending recess, in order to provide positive torque generated by air flow along the trailing edge. The flow can be deflected into or out of the rotation circle, or both, depending on the blade design, as designed above.

As indicated earlier, the turbine blade used in the rotary blade assembly illustrated in FIGS. 4-7, provides a large self-starting capability, and also a large speed-limiting capability under high wind conditions. However, these advantages are at the expense of relatively poor efficiency in steady wind conditions.

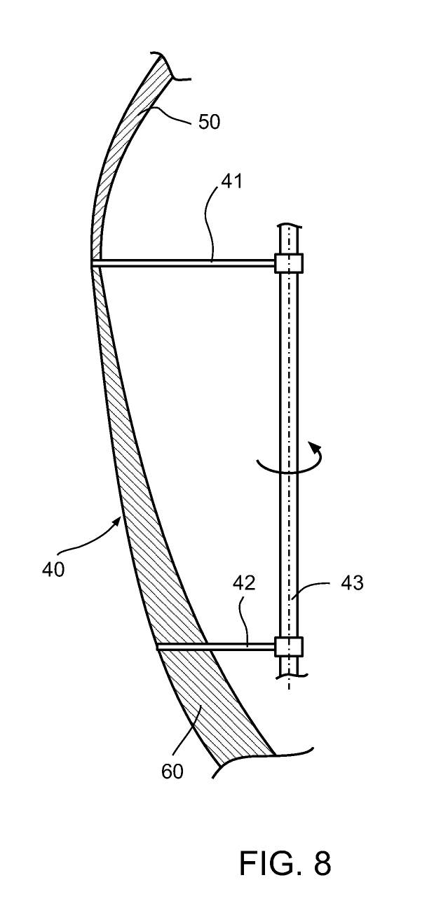

### The Embodiments of FIGS. 8-12

The embodiment of FIGS. 8-12 is particularly useful to increase the efficiency of the turbine blade during steady wind conditions. This construction is based on similar principles as the above-discussed FIGS. 4-7 embodiment, except for the following: First, the inwardly-extending recess in the end regions of the blade trailing edges (corresponding to recess 18 in FIG. 4) is a shallow recess terminating short of the chord line, rather than a deep recess extending past the chord line as in FIG. 4. Secondly, instead of having the chord lines be of uniform length in the outer end regions as well as in the central region, as in the FIGS. 4-7 embodiments, the chord lines in the embodiment of FIGS. 8-12 are of uniform length in the central region, and increase in length from the central region to the outer end regions, to thereby produce outwardly-tapered or flared end regions at each of the opposite ends of the central region.

FIG. 8 illustrates a turbine blade constructed in accordance with the foregoing features. It is constituted of a middle blade segment, generally designated 40, and is joined at its opposite ends to two end blade segments, schematically identified as 50 and 60, respectively. Each such blade segment is of the same configuration and joined to a vertical rotary shaft 43 rotatable about its vertical-axis by a pair of arms at the opposite sides of the respective segment, as shown by arms 41 and 42 with respect to segment 40.

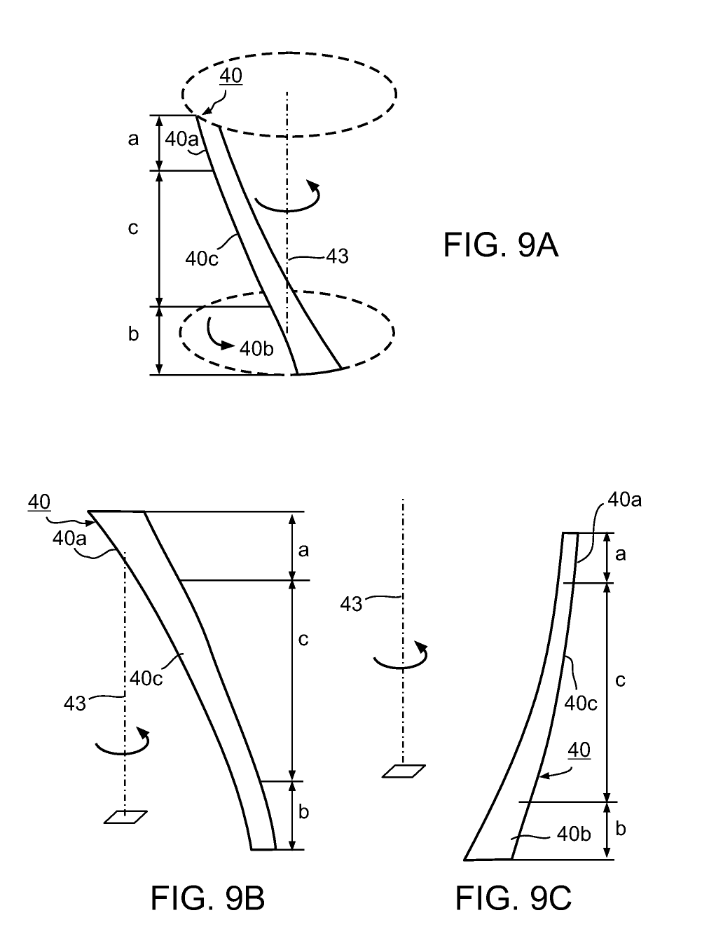

As shown particularly in FIG. 9A, each segment, e.g. segment 40, is twisted into a helical configuration, with the direction of the helix being opposite to the direction of rotation of the vertical rotary shaft 43. Thus, as shown in FIG. 9a, the bottom part 40b of segment 40 leads the top part 40a of the segment during the rotation of the blade about the axis of the vertical rotary shaft 43.

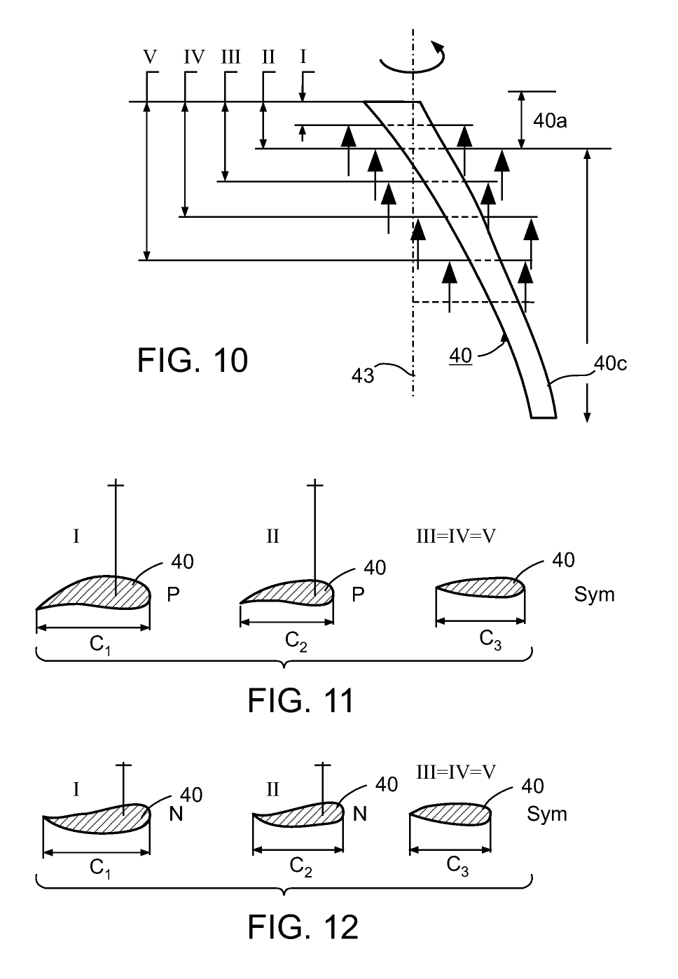

As shown in FIG. 9B, end region 40a of the turbine segment 40 is outwardly tapered or flared with respect to the middle region 40c; and as shown in FIG. 9C, the opposite end region 40b of the turbine segment is similarly outwardly tapered or flared with respect to the middle region 40c. As shown more particularly in FIGS. 10-12, the outwardly tapered or flared regions 40a, 40b are produced by increasing the lengths of the chord lines (C) in these outer regions with respect to the lengths of the chord lines in the middle region 40b. In FIGS. 9A-9C, the lengths of the outwardly tapered end regions 40a and 40b are indicated as “a” and “b”, respectively, while the length of the middle region 40c, in which the chord lines are of uniform length, is indicated as “c”.

Regions “a” and “b” may be substantially the same length, but in most preferred configurations they would not be the same. In addition, in most cases, “a” and “b” would be equal to or less than “c” but in some applications, particularly in very small turbines for rooftop assembly or for urban environments, “a” plus “b” would be greater than “c”.

FIG. 10 illustrates a fragment of a blade segment 40, including one end region 40a and the adjacent portion of the middle region 40. The portion of the blade segment illustrated in FIG. 10 is provided with section lines I-V; FIG. 11 illustrates the configuration of the sections along the respective section lines.

Section lines I and II illustrate the outwardly tapered or flared end region 40a of the blade segment 40, whereas section lines III-V illustrate the section in the middle region 40c.

As shown in FIG. 11, the chord line C₁ in the outermost section of section line I is of a larger length than the chord line C₂ in the next adjacent section represented by section line II, thereby showing the outwardly tapered or flared configuration of the outer region 40a. On the other hand, the lengths of the chord lines along each of sections III, IV and V, as represented by C₃ in FIG. 11, are of equal length. Thus, as seen in FIGS. 10 and 11, C₁ is greater than C₂, which in turn is greater than C₃.

It will be appreciated that the end region 40b at the opposite end of the illustrated blade segment 40 will be of a similar outwardly tapered or flared construction as described above with respect to end region 40a.

It will also be seen from FIG. 11 that the blade segment is cambered in the tapered end portion 40a of its sharp trailing edge. FIG. 11 illustrates the blade in this region as being positively cambered, i.e. in the surface of the blade segment facing the rotary axis 43 during the rotation of the blade segment. FIG. 12 illustrates the opposite arrangement, wherein the camber is negative, i.e. in the surface of the blade segment facing away from the axis of rotation. The positive camber assists in self-starting because of to the increase in lift at low TSR values; the negative camber assists in self-breaking at over-speed conditions (i.e., the speed-limiting capability) due to an earlier dynamic stall, and a high reduction of the lift (versus the symmetric airfoil of the central section) at this condition.

The tip of the chord at each end region is about 10-50% larger than the chord at the central region and is uniformly shortened to the central region.

The total length of each trailing edge is preferably tapered 20% to 30% of the blade's total length. The taper length of one trailing edge is not necessarily equal to the taper length of the other trailing edge. The total length of the two tapered edges together is preferably 40% to 60% of the blade length, such that the length of the central region is 60% to 40%. The contribution of the tapered trailing edges is mainly to enable self-starting of the rotor, although the average chord length, or the averaged solidity, cannot ensure self-starting at al conditions (especially at low wind speeds).

Each tapered edge can be completely a negative camber or completely a positive camber. In addition, there is a possibility to use both a negative and positive camber on some tip edges with a low symmetrical air flow in the transfer section between them. The exact length where the transfer takes place is dependent on the design requirements. In most cases, where the use of both negative and positive cambers is required, one tapered edge will have a positive camber, and the other will have a negative camber. In such case, the lengths “d” and “e” of the tapered edges will depend on the specific camber used.

The aerodynamic characteristics of an airfoil differ between situations of curvilinear flow fields and rectilinear flow fields. Also, the wind speed at the turbine upstream, while primarily flooding the blade, is always higher than that flooding the blade close to the downstream side. Both phenomena can assist the aerodynamic braking at over speeding conditions, using variable airfoil cambering along the trailing tapered edges as described above. At normal conditions, the cambered trailing edges will contribute to the lift by almost the same level as the central region. During over-speeding conditions, the cambered trailing edges will reach stall prior to the central region and will assist in the generated torque reduction (braking). The variable camber along the tapered trailing edges can stretch the “penetration” into the dynamic stall conditions to avoid sudden fluctuations of the generated torque.

In the embodiments of FIGS. 8-12, the central region of the blade segment has a constant, relatively short chord. Its airfoil is symmetrical as described above. The standard lift machines are equipped with symmetrical airfoil in the range of NACA 0012-NACA 0018. As mentioned earlier, these airfoils have a thickness to chord length ratio of 12% to 18%. The central region in the embodiments of FIGS. 8-12 can be equipped with one of these airfoils, where mechanical strength properties are more important than the required performance.

As also mentioned earlier, the typical lift machine chord is calculated from the solidity definition of the rotor: σ=N*C/Dr, where N is the number of blades. Low solidity is related to high TSR and high conversion efficiency. It is also less affected from curvilinear flow field to rectilinear flow field conversion. The low solidity at the central region of the rotor is achieved by using short chords and low thickness. On the other hand, this section will not contribute to the self-start capabilities and will not contribute to the aerodynamic braking at high rotation speed as its lift at dynamic stall is relatively high.

There are applications where the reduction the turbine aerodynamic noise is required. This can be achieved by setting the TSR value lower than the above range (2<λ<3). In these cases, the central region can use thicker airfoils and slightly longer chords. Both can contribute to the price reduction of the blade segment production.

While the invention has been described with respect to two preferred embodiments, it will be appreciated that these are set forth merely for purposes of example, and that many other variations, modifications and applications of the invention may be made.

1. A turbine blade particularly useful in a vertical-axis wind turbine, said turbine blade including outer surfaces defining between them a rounded leading edge, a sharp trailing edge, and a chord line extending from said rounded leading edge to said sharp trailing edge; characterized in that the blade includes a central region of a symmetrical airfoil configuration in which the chord line extends midway between its outer surfaces; and opposite end regions each of a non-symmetrical airfoil configuration with respect to said chord line effective to increase the drag forces produced by the wind at the end regions when the turbine blade is used in a vertical-axis wind turbine, sufficient to provide a self-starting capability, and a speed-limiting capability, to the wind turbine.

2. The turbine blade according to claim 1, wherein the blade is constituted of a plurality of segments joined to each other end-to-end, with each of said segments including a said central region of symmetrical airfoil configuration, and said end regions of non-symmetrical airfoil configuration.

3. The turbine blade according to claim 1, wherein said symmetrical airfoil configuration of the central region is of a tear-drop configuration, including a rounded leading edge, a sharp trailing edge, and a chord line extending from said rounded leading edge to said sharp trading edge midway between the outer surfaces of said turbine blade;
and wherein said non-symmetrical airfoil configuration of the end regions includes an inwardly-extending recess at said sharp trailing edge of each end region.

4. The turbine blade according to claim 3, wherein the turbine blade is constructed for mounting its opposite ends to a vertical rotary shaft rotatable about a vertical rotary axis, with one surface of the blade facing towards said vertical rotary axis, and an opposite surface of the blade facing away from said vertical rotary axis.

5. The turbine blade according to claim 4, wherein said inwardly-extending recess at the sharp trailing edge of the blade is formed in said one surface of the blade facing towards said rotary axis such as to define a positive camber to said sharp trailing edge.

6. The turbine blade according to claim 4, wherein said inwardly-extending recess at the sharp trailing edge of the blade is formed in said opposite surface of the blade facing away from said vertical rotary axis such as to define a negative camber in said sharp trailing edge.

7. The turbine blade according to claim 4, wherein the blade is of a helical configuration with the helix extending in the opposite direction to the direction of rotation of the turbine blade about said vertical rotary axis such that the bottom of the blade leads the top of the blade during the rotation of the blade.

8. The turbine blade according to claim 4, wherein said inwardly-extending recess is a deep recess extending inwardly past said chord line at said sharp trailing edge of the blade, to increase the drag forces and thereby enhance said self-starting and speed-limiting capabilities.

9. The turbine blade according to claim 8, wherein said deep recess begins at a distance of less than one-half the length of the chord line from the rounded leading edge and extends to the sharp trailing edge of the blade.

10. The turbine blade according to claim 8, wherein said deep recess begins at a distance of one-third the length of the chord line from the rounded leading edge and extends to the sharp trailing edge of the blade.

11. The turbine blade according to claim 8, wherein said deep recess is defined by a radius-of-curvature of about 0.3 times the length of the chord line.

12. The turbine blade according to claim 8, wherein said central region and said end regions have chord lines of equal lengths.

13. The turbine blade according to claim 12, wherein the blade is constituted of a plurality of segments joined to each other end-to-end, with each of said segments including a said central region of symmetrical airfoil configuration, and said end regions of non-symmetrical airfoil configuration.

14. The turbine blade according to claim 4, wherein said inwardly-extending recess is a shallow recess and terminates short of said chord line at said sharp trailing edge to thereby enhance the efficiency of the wind turbine at normal wind speeds.

15. The turbine blade according to claim 14, wherein the chord lines are of uniform length in said central region, and of increasing length from said central region to the outer ends of the end regions to define an outwardly-flared end region at each of the opposite ends of the central region.

16. The turbine blade according to claim 14, wherein said shallow recess at the sharp trailing edge of the blade is formed in said one surface of the blade facing towards said rotary axis such as to define a positive camber to said sharp trailing edge.

17. The turbine blade according to claim 14, wherein said shallow recess at the sharp trailing edge of the blade is formed in said opposite surface of the blade facing away from said vertical rotary axis such as to define a negative camber in said sharp trailing edge.

18. The turbine blade according to claim 14, wherein the blade is of a helical configuration with the helix extending in the opposite direction to the direction of rotation of the turbine blade about said vertical rotary axis such that the bottom of the blade leads the top of the blade during the rotation of the blade.

19. The turbine blade according to claim 14, wherein the blade is constituted of a plurality of segments joined to each other end-to-end, with each of said segments including a said central region of symmetrical airfoil configuration, and said end regions of non-symmetrical airfoil configuration.

20. A turbine blade particularly useful in a vertical-axis wind turbine, said blade including a rounded leading edge and a sharp trailing edge;
characterized in that said blade includes a central region having chords of equal length, and end regions on the opposite ends of said central region having chords of increasing length towards the outer tip of each end region.

21. The turbine blade according to claim 20, wherein each of said end regions is formed with a positive camber.

22. The turbine blade according to claim 20, wherein each of said regions is formed with a negative camber.

23. The turbine blade according to claim 20, wherein one of said end regions is formed with a positive camber and the other end region is formed with a negative camber.

24. The turbine blade according to claim 20, wherein the blade is of a helical configuration with the helix extending in the opposite direction to the direction of rotation of the turbine blade about the vertical rotary axis of a vertical-axis wind turbine when used therein, such that the bottom of the blade leads the top of the blade during the rotation of the blade.

25. The turbine blade according to claim 20, wherein the blade is constituted of a plurality of segments joined to each other end-to-end, including a said central region and a said end region at each of the opposite ends of the central region.

26. A vertical-axis wind turbine, comprising:
a plurality of blades each according to claim 1 mounted to a vertical rotary shaft by coupling arms at the opposite ends of each blade to define a rotary blade assembly in which the blades are circumferentially spaced from each other, and their ends are radially spaced from the vertical rotary shaft.

27. The wind turbine according to claim 26, wherein each of said plurality of blades has a helical configuration in which the helical direction of the blade is opposite to the direction of rotation of the rotor assembly, such that the bottom parts of the helical blades lead the top parts of the helical blades during the rotation of the rotary blade assembly.

28. The wind turbine according to claim 26, wherein said symmetrical airfoil configuration of the central region of each of said blades is of a tear-drop configuration, including a rounded leading edge, a sharp trailing edge, and a chord line extending from said round leading edge to said sharp trading edge midway between the outer surfaces of said turbine blade;
and wherein said non-symmetrical airfoil configuration of the end regions includes an inwardly-extending recess at said sharp trailing edge of each end region.

29. The wind turbine according to claim 26, wherein each turbine blade is constructed for mounting its opposite ends to a vertical rotary shaft rotatable about a vertical rotary axis, with one surface of the blade facing towards said vertical rotary axis, and an opposite surface of the blade facing away from said vertical rotary axis.

30. The wind turbine according to claim 29, wherein said inwardly extending recess of each blade is a deep recess extending inwardly past said chord line at said sharp trailing edge of the blade, effective to increase the drag forces, and thereby enhance the self-starting and the speed-limited capabilities.

31. The wind turbine according to claim 29, wherein said inwardly-extending recess of each blade is a shallow recess and terminates short of said chord line at said sharp trailing edge to thereby enhance the efficiency of the wind turbine at normal wind speeds.

32. The wind turbine according to claim 31, wherein the chord lines of each blade are of uniform length in said central region, and of increasing length from said central region to the outer ends of the end regions to define an outwardly-flared end region at each of the opposite ends of the central region.

33. The wind turbine according to claim 26, wherein each blade is constituted of a plurality of segments joined to each other end-to-end, with each of said segments including a said central region of symmetrical airfoil configuration, and said end regions of non-symmetrical airfoil configuration.

34. A vertical-axis wind turbine, comprising:
a plurality of blades mounted to a vertical rotary shaft to define a rotary blade assembly in which the blades are circumferentially spaced from each other and their ends are radially spaced from the vertical rotary shaft;
said plurality of blades having a helical configuration in which the helical direction of each blade is opposite to the direction of rotation of the rotor assembly, such that the bottom parts of the helical blades lead the top parts of the helical blades during the rotation of the rotary blade assembly.

35. The wind turbine according to claim 34, wherein each blade has a configuration at each of its central region, including a rounded leading edge, a sharp trailing edge, and a chord line extending from said round leading edge to said sharp trading edge midway between the outer surfaces of said turbine blade;
and wherein each blade has a non-symmetrical airfoil configuration its end regions including an inwardly-extending recess at said sharp trailing edge of each end region.

36. The wind turbine according to claim 29, wherein each turbine blade is mounted at its opposite ends to said vertical rotary shaft by a pair of arms spacing the opposite ends of the turbine blade from the vertical rotary shaft, with one surface of the blade facing towards said vertical rotary shaft. and an opposite surface of the blade facing away from said vertical rotary axis.

37. The wind turbine according to claim 30, wherein said inwardly extending recess of each blade is a deep recess extending inwardly past said chord line at said sharp trailing edge of the blade, effective to increase the drag forces, and thereby enhance the self-starting and the speed-limited capabilities.

38. The wind turbine according to claim 35, wherein said inwardly-extending recess of each blade is a shallow recess and terminates short of said chord line at said sharp trailing edge to thereby enhance the efficiency of the wind turbine at normal wind speeds.

39. The wind turbine according to claim 38, wherein the chord lines of each blade are of uniform length in said central region, and of increasing length from said central region to the outer ends of the end regions to define an outwardly-flared end region at each of the opposite ends of the central region.

40. The wind turbine according to claim 35, wherein each blade is constituted of a plurality of segments joined to each other end-to-end, with each of said segments including a said central region of symmetrical airfoil configuration, and said end regions of non-symmetrical airfoil configuration.
